(19) United States
(12) Patent Application Publication
(10) Pub. No.: US 2011/0274485 A1
(43) Pub. Date: Nov. 10, 2011

(54) Profiled Members for Transferring Torques and Torque-Locked Connection

(75) Inventor: Thorsten Schraer, Jetzendorf (DE)

(73) Assignee: RUIA GLOBAL FASTENERS AG, Neuss (DE)

(21) Appl. No.: 13/144,060

(22) PCT Filed: Dec. 30, 2009
(86) PCT No.: PCT/DE2009/050080

§ 371 Date: Jul. 11, 2011

(30) Foreign Application Priority Data
Jan. 15, 2009 (DE) 20 2009 000 623.9

(51) Int. Cl. F16B 35/04

(52) U.S. Cl. 403/320

(57) ABSTRACT

A torque-locked connection between a hub or disk (14) and a shaft, a journal or a shank (12), wherein the hub or disk (14) is provided with a profiled passage for the shaft, the journal or the shank (12) and said shaft, journal or shank in turn is provided with a corresponding outside profile (16) and an outside thread (26) following said outside profile (16), said outside thread being used to screw on a nut so as to secure the hub or disk (14), wherein the difference between the outside diameter of the outside thread (26) and the outer surrounding diameter of the profile (16) is no more than 1 mm.

### TECHNICAL FIELD

The problem of producing a torque-locked connection between journals, shafts, shanks or other elongate elements, such as bolts and rods, and hubs mounted thereon, such as gearwheels, pinion gears or discs is often encountered in the field of engineering.

### PRIOR ART

With such a shaft-hub connection, the corresponding journals, shafts, pins, rods or similar elements thus usually comprise a slot-key design or a knurl in order to transfer torque. Alternatively, an embodiment of the shaft or shank as a polygon, preferably as a square or hexagon with a corresponding counter-contour in the hub part, is common. All these solutions according to the prior art pose the considerable drawback that a large difference in diameter is necessary between the actual shank and the contour which transfers the torque. For example, a square shank which is conventional in accordance with the prior art and has a width across flats of 12 mm (this corresponds to the inner surrounding circle) has a diameter over the corners of approximately 17 mm. This corresponds to the outer surrounding circle.

This leads to an unnecessary usage of space and considerable additional weight in all such constructions which are to transfer torques between a shank and a hub part mounted thereon.

This problem is particularly disadvantageous in shaft-hub connections in which an external thread has to be arranged on the shaft in addition to the outer profile, which external thread axially secures or fixes the hub part via a nut screwed onto said external thread. For example, this is particularly disadvantageous in “stepped eccentric screws” for adjusting camber and track in motor vehicle running gears, since the eccentric screw has to be formed so as to be particularly thick and therefore heavy and expensive owing to the difference in diameter between the large, profiled shank diameter or shank extension compared to the thread part. This is necessary in automotive engineering because the profiled member has to be able to transfer torques of 100 Nm and more when the running gears are adjusted.

Previously, only very distinctive profiled members were considered to be suitable for this purpose. The current prior art thus includes designs with a trapezoid square shank, as described for example by ABC in its utility model DE 202 09 505. These eccentric screws have a difference in diameter of at least 4 mm between the outer surrounding circle of the profiled member and the thread diameter. Lastly, the corresponding inner profiled member of the hub part has to pass over the external thread. For this purpose it has been attempted to accordingly provide the profiling with an interrupted external thread. However, this has not proven to be successful since, as a result of the corresponding interruptions in the external thread, the mechanical properties have been considerably worsened, in particular when tightening the nuts. The risk of snapping or destroying the accordingly interrupted external thread is considerable.

Therefore, it has until now been necessary to tolerate the additional spatial requirement, which is highly inconvenient for the designer particularly in the case of motor vehicle running gears, and the additional weight of the eccentric screw shaft which is thus considerably oversized.

### DESCRIPTION OF THE INVENTION

The object of the present invention is therefore to provide a connection between a shaft and a hub part, as well as a suitable profiled member therefor, which connection is suitable for the transfer of large torques, wherein the shank does not have to be oversized, yet a sufficient transfer of torque and a continuous, i.e. uninterrupted external thread are sill provided.

In accordance with the invention this object is achieved by profiled members for transferring torques between a hub and a journal or a shaft, wherein the hub is secured by a nut screwed onto a continuous external thread attached to the profiled member, and the difference between the outer diameter of the external thread and the outer surrounding circle of the profiled member is no more than 1 mm.

In accordance with the invention a specific profiled member can, for the first time, be created in which the lowest point of the profiled member on the shank is positioned radially lower than the thread diameter of the external thread after the rolling or milling of the thread. This means that in accordance with the invention, the lowest point of the profiled member of the shank can be just as low as the diameter of the external thread before the milling or rolling process. The size of the thread prior to milling thus corresponds approximately to the pitch diameter.

In accordance with the invention the hub part or other components comprising the negative profiled member of the shank is/are to be passed over the thread in spite of the above.

In accordance with the invention this object is achieved in that the profiled member on the side of the shank, journal or shaft is formed of recesses, having the shape of a circle sector, in the shank, journal or shaft, and the profiled member on the side of the hub, i.e. the negative profiled member, is formed of corresponding projections having the shape of a circle sector and comprising in their centre reliefs having the shape of a circle sector, in such a way that with the inter-engagement of the two profiled members a cross-section corresponding to the cross-section of a convex lens remains open.

The present invention is specifically based on the finding that with such profiled members formed in the shape of a circle sector, torque is transferred substantially only in the edge regions of the sectors. Hardly any torque is transferred in the inner region of the profiled members having the shape of a circle sector, which region extends virtually tangentially to the direction of torque. A relief having the shape of a circle sector can thus in turn be provided in this region in the hub-side, i.e. protruding profiled member, through which relief the hub passes over the external thread without substantially reducing the ability of the profiled member to transfer torques.

In accordance with the invention it is thus possible, for the first time, to insert the hub or disc over the thread with merely a difference in diameter of 1 mm between the shank diameter and the thread diameter and, in spite of this, to still achieve a sufficient interlocking fit in the grooves in the shank in order to transfer high torques. The torque to be transferred can also be increased with the number of grooves in the shank (more grooves transfer more torque).

In accordance with the invention it is also not necessary to interrupt the external thread for this purpose. Rather, a full external thread with full bearing capacity is provided in accordance with the invention.

It is particularly preferable to position the reliefs having the shape of a circle sector in the profiled member on the side of the hub concentrically with the external thread in the assembled state of said hub, and to select the radius of the circle sectors of the reliefs in such a way that it is slightly larger than the outer radius of the external thread.

The depth of the profiled members formed on the journal or the shaft particularly preferably decreases in the direction of mounting of the hub. The hub part is thus self-centred on the shank when the nut screwed onto the external thread is tightened.

A further advantage of the present invention lies in that the profiled member on the shaft or journal can be produced without cutting production steps exclusively by pressing, rolling and/or milling. The profiled member of the shaft or journal can thus be produced with pressing of the shank, in such a way that the recesses can be produced without additional processing steps. In this case the thread is rolled on or milled in a second step. However, the profiled member according to the invention can also be milled, in which case it can also be produced at the same time as the external thread in a single production step without the need for additional, complex cutting production steps.

With regard to an optimal transfer of torque, at least three, preferably five recesses are formed in the shaft, the shank or the journal.

The object according to the invention is also achieved by a torque-locked connection between a hub or disc and a shaft, a journal or a shank, in which the hub or disc is provided with a profiled opening for the shaft, journal or shank and these comprised corresponding outer profiling which is formed of recesses in the shaft, journal or shank having the shape of a circle sector and extending parallel to the axis of rotation of the shaft, journal or shank, wherein the profiled member of the opening is formed with corresponding protrusions having the shape of a circle sector which comprise reliefs, having the shape of a circle sector, in their centre region, in such a way that with the inter-engagement of the profiled members a cross-section corresponding to the cross-section of a convex lens remains open.

If an external thread is also formed on the shaft, journal or shank in addition to the profiling, which external thread normally secures the corresponding hub or disc by the screwing of a nut onto said external thread, the reliefs which are formed in the profiled member on the side of the hub or disc and have the shape of a circle sector are particularly preferably positioned concentrically with the external thread in the mounted state of said hub or disc, and the circle sectors have a radius which is slightly larger than the outer radius of the external thread.

In accordance with the invention the depth of the profiled members formed on the shaft, journal or shank further particularly preferably decreases in the direction of mounting of the hub or disc. The hub or disc is thus self-centred or self-orientated when the nut is tightened.

A further particular advantage of the present invention is that the profiled member on the shaft, journal or shank can be produced without cutting production steps exclusively by pressing, rolling and/or milling. The normally very complex cutting production steps are thus omitted and the profiled member can be produced simultaneously with the production of the external thread in a single processing step.

In terms of a maximally optimal transfer of torque, it is particularly preferable in accordance with the invention to form at least three, but preferably five recesses in the shaft, journal or shank.

The present invention will be explained in greater detail hereinafter with reference to the embodiment shown in the accompanying drawings, in which:

### BRIEF DESCRIPTION OF THE DRAWINGS

FIG. 1 is a plan view of a shank and a disc comprising the profiled member according to the invention viewed in the direction of the axis of rotation;

FIG. 2a shows the disc in the viewing direction of FIG. 1, wherein the circles of the corresponding radii are illustrated for improved comprehension;

FIG. 2b shows the detail X of FIG. 2a;

FIG. 3a shows a shank according to the invention for an eccentric screw or eccentric rod, shown in part, viewed from the side;

FIG. 3b shows the shank of FIG. 3a from the front (viewed in the direction onto the head), wherein the head is not shown; and

FIG. 4 shows the section B-B through the shank according to FIGS. 3a and 3b.

### PREFERRED EMBODIMENT OF THE INVENTION

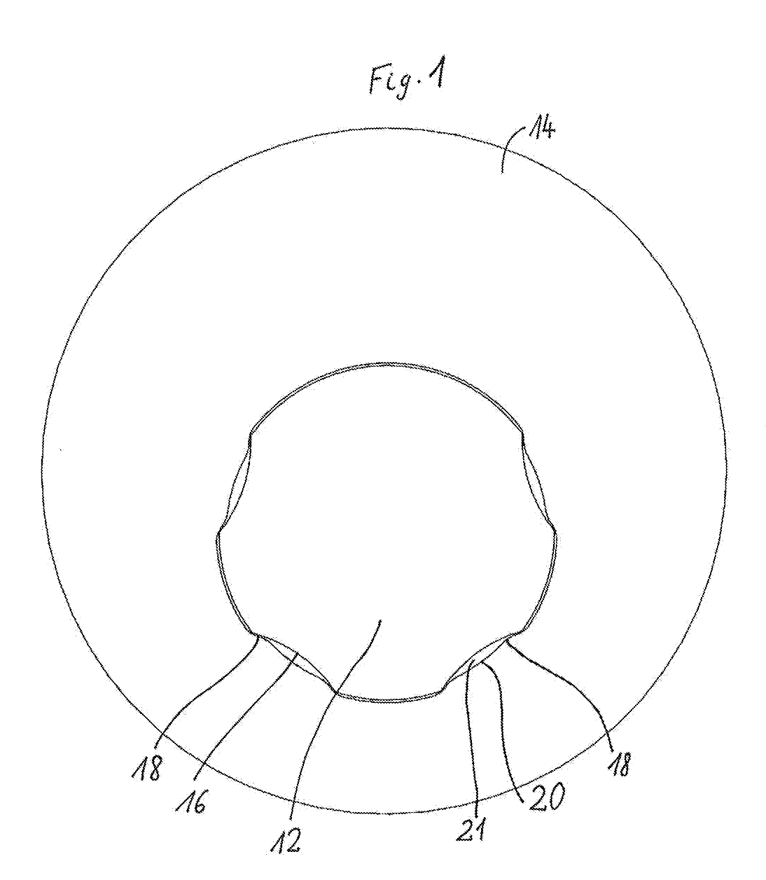

FIG. 1 is a plan view in the axial direction of a shank 12 according to the invention onto which a disc 14 according to the invention has already been mounted. In the case shown, this is an application for an eccentric screw or eccentric rod. The disc 14 is therefore eccentric and the profiled member is formed in such a way that it is only possible to mount the disc 14 on the shank 12 in a single angular position.

In accordance with the invention the profiled member on the shank 12 consists of recesses 16 having the shape of a circle sector, wherein the maximum depth (distance between the surface of the lowest point of the recess and the outer surrounding circle of the shaft 12) is approximately 1 mm and the radius of the circle sectors, which define the recesses 16, is smaller than the radius of the shank 12. In the embodiment shown four such recesses 16 are provided. Of course, in particular with large shank diameters and large torques to be transferred, substantially more recesses can be provided distributed over the periphery of the shank 12.

In the present case the upper recess has been left out so as to enforce a clear angular assignment of the eccentric disc. In other applications, for example when mounting a gearwheel or a pinion on a shaft, a further recess may of course also be provided at this point and all recesses may be distributed uniformly over the periphery of the shank 12. However, in this case no clear angular assignment is ensured between the shank 12 and the disc 14.

With very small shank diameters the number of recesses may, of course, also be reduced compared to the example shown to merely a single recess.

The corresponding counter-profiled member on the disc 14 consists of corresponding protrusions 18 having the shape of a circle sector.

In accordance with the invention however, these comprise reliefs 20, again having the shape of a circle sector, in their centre region, which reliefs correspond to the outer contour of the external thread 26 and may be slightly larger, such that the disc 14 also can be slid over the external thread 26 without difficulty. The reliefs 20 thus have a radius which is slightly greater than the outer radius of the external thread 26 and extend concentrically with the axis of rotation of the shank 12.

A cross-section 21 between the shank 12 and the disc 14 is thus open, allows the external thread 26 to pass through the disc 14 and has the shape of the cross-section of a convex lens, i.e. corresponds to an opening which is defined by two intersecting circle arcs having different radii.

Previously, in this regard it was assumed that a maximum non-positive fit and thus torque lock would be achieved if the profiled members of the shank and of the disc matched one another as precisely as possible. With the present invention it was recognised for the first time that with profiled members having the shape of a circle sector, the centre region of the profiled members, i.e. the region of the profiled members in which the boundary line between the profiled members extends substantially tangential to the surface of the shank 12, hardly contributes to the transfer of force and torque, and that the region in question can thus be cut out in such a way that the external thread 26 can pass through the disc 14. The present invention is thus based on the finding that, in spite of this, a very good transfer of torque is ensured between the shank 12 and the disc 14, although the profiled member of the shank 12 and the profiled member of the disc 14 merely engage in relatively small regions.

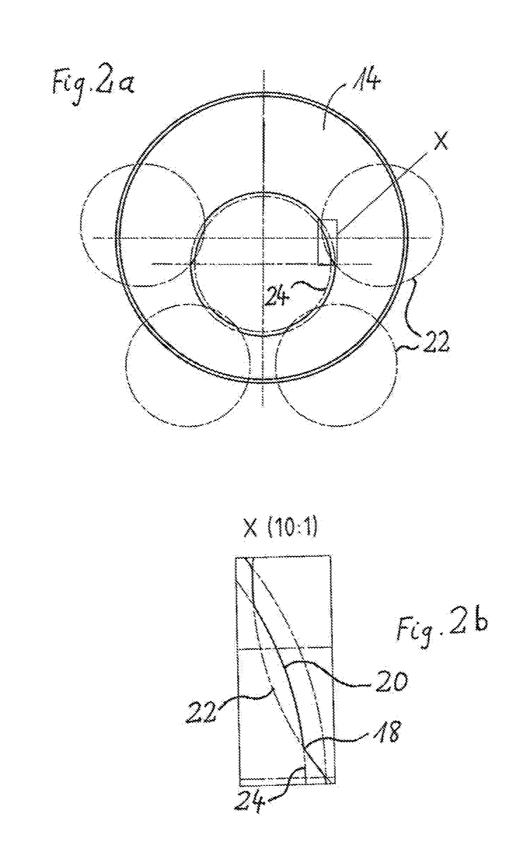

In order to further better illustrate the profiled member in FIG. 1, FIG. 2a shows the geometric constructions necessary for the profiled member illustrated in FIG. 1. As shown in FIG. 2a, the recesses 16 are formed in the shank 12 by circle sectors of circles 22 which have a slightly smaller diameter than the shank 12. The recess 20 in the convex protrusion 18 of the disc 14 is defined by a circle 24 which corresponds to the surrounding circle of the external thread 26 on the shank 12, or has a slightly larger diameter than this surrounding circle and is concentric with this surrounding circle.

FIG. 2b shows the detail X of FIG. 2a so the geometric construction of the relief 20 in the protrusion 18 can be seen more clearly by means of the circles 22 and 24.

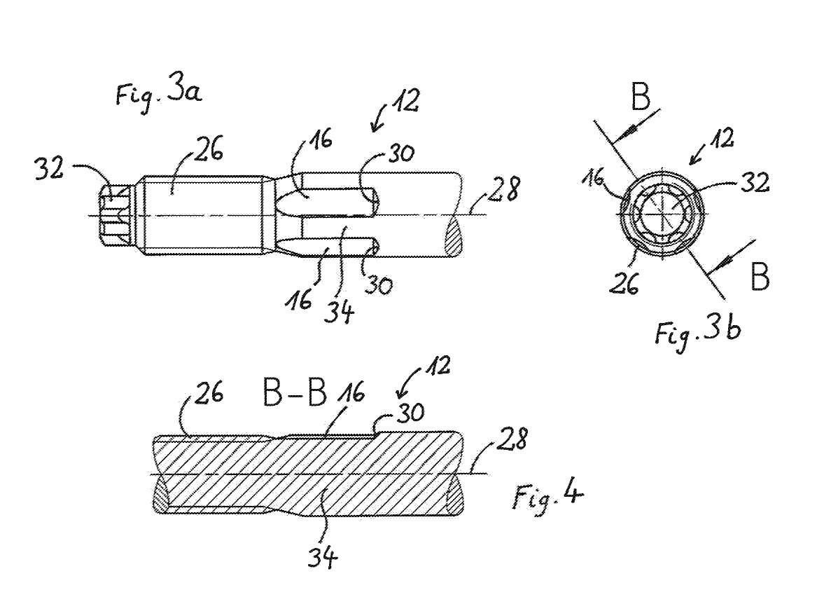

FIG. 3a shows the end of a shank 12 according to the invention which carries an external thread 26 on its free end. This external thread is used to screw on a nut after a corresponding disc or a corresponding gearwheel or pinion has been slid onto the shank 12. It can be seen clearly from the side that the profiled members 16 having the shape of a circle sector extend parallel to the axis of rotation 28 of the shank 12.

In this embodiment the end of the shank 12 is provided with a point of application of force 32. The external thread 26 is connected to this. After the external thread 26 there is a profiled region 34 which comprises the profiled members 16 having the shape of a circle sector.

These profiled reliefs 16 extend diagonally in the direction away from the external thread 26, preferably at an angle of 45° to the surface of the shank 12. Regions 30 in which the profiled reliefs 16 transition with decreasing depth into the normal outer surface of the shaft 12 are thus formed. This design preferably makes it possible for a corresponding disc 14, gearwheel or pinion to be self-centred on the shank 12 when a nut screwed onto the external thread 26 is tightened. This is shown in greater detail in FIG. 4.

FIG. 3b shows the portion of the shank 12 illustrated in FIG. 3 viewed from the point of application of force 32. From the inside out, the point of application of force 32, the external thread 26 and therebehind the profiled shank region 34 with the recesses 16 can be seen. In order to better understand the illustration, the surrounding circle 26 is in this case drawn in such a way that the entire course of the recesses 16 located behind is shown continuously. It should be noted that, normally, the inner regions of the recesses 16 are covered by the outer surrounding circle of the external thread 26 and should not therefore be shown in accordance with the rules of technical drawing.

In the present form, however, FIG. 3b should be better adapted for understanding the operation of the present invention and, in particular, the shaping for the blanking in the disc 14. In particular, it can be seen in FIG. 3b that the profilings 16 on the shank are actually deeper than the outer surrounding circle of the external thread 26.

FIG. 4 shows the sectional view along B-B of FIG. 3b and merely one of the recesses 16 of the profiled member is therefore shown, it being possible to see the transition 30 of this profiled member 16 into the normal outer surface of the shank 12. In the present case this transition occurs at an angle of 45°, but smaller or steeper angles may also be selected for this transition. The self-centring and self-orientation of a hub part mounted on this shank is thus ensured when a nut screwed onto the external thread 26 is tightened.

The present invention affords the following advantages:

It is possible, with a difference in diameter between the shank and the thread of merely 1 mm, to still transfer considerable torques without having to dispense with a continuous external thread. Owing to the specific geometry in accordance with the invention of the profiled member on the hub part (reliefs 20), it is possible to provide a continuous external thread 26 and still slide a hub part 14 over said external thread, although the profiled member 16 of the shank 12 is deeper than the outer diameter of the external thread 26.

The design according to the invention of the shank 12 further affords the advantage that the shank 12 can be produced completely by pressing and rolling or milling without any subsequent cutting processes such as grinding or facing.

Astonishingly, the profiled member according to the invention even provides a better transfer of torque than a hexagonal profiled member of equal size from the prior art.

1-12. (canceled)

13. Profiled members for transferring torques between a hub and a shank, a journal or a shaft, the hub being secured by a nut screwed onto a continuous external thread attached to the profiled member, characterized in that the lowest point of the profiled member on the shank, on the journal or on the shaft is radially lower than the thread diameter of the external thread after the rolling or milling of the thread, and the hub or other components comprising the negative profiled member of the shank can be passed over the external thread in spite of this.

14. Profiled members for transferring torques between a hub and a shank, a journal or a shaft, the hub being secured by a nut screwed onto a continuous external thread attached to the profiled member, characterized in that the lowest point of the profiled member of the shank, journal or shaft is just as low as the diameter of the external thread in the raw state, i.e. before the milling or rolling process.

15. Profiled members according to either claim 13 or claim 14, characterized in that the profiled member on the side of the shank, journal or shaft is formed of recesses, having the shape of a circle sector, in the shank, journal or shaft, and the profiled member on the side of the hub is formed of corresponding protrusions having the shape of a circle sector and comprising in their centre reliefs having the shape of a circle sector, in such a way that with the inter-engagement of the profiled members a cross-section corresponding to the cross-section of a convex lens remains open.

16. Profiled members according to claim 15, an external thread being arranged on the journal or shaft in addition to the profiled part, which external thread secures the corresponding hub by screwing on a nut, characterized in that the reliefs, having the shape of a circle sector, in the profiled member on the side of the hub are arranged concentrically with the external thread in the assembled state of said hub and have a radius of the shape of a circle sector which is slightly larger than the outer radius of the external thread.

17. Profiled members according to claim 15, characterized in that the depth of the profiled members formed on the journal or the shaft decreases in the direction of mounting of the hub.

18. Profiled members according to either claim 13 or claim 14, characterized in that the profiled member on the shaft, shank or journal is produced without cutting production steps exclusively by pressing, rolling and/or milling.

19. Profiled members according to either claim 13 or claim 14, characterized in that at least three, preferably five recesses are formed in the shaft or journal.

20. Torque-locked connection between a hub or disc and a shaft, a journal or a shank, the hub or disc being provided with a profiled opening for the shaft, journal or shank and these comprising a corresponding outer profiling and an external thread attached to said outer profiling, said external thread being provided for the screwing-on of a nut in order to secure the hub or disc, characterised in that the lowest point of the outer profiling is radially lower than the thread diameter of the external thread after the rolling or milling of the thread, and the hub or other disc can be passed over the external thread in spite of this.

21. Torque-locked connection between a hub or disc and a shaft, a journal or a shank, the hub or disc being provided with a profiled opening for the shaft, journal or shank and these comprising a corresponding outer profiling and an external thread attached to said outer profiling, said external thread being provided for the screwing-on of a nut in order to secure the hub or disc, characterized in that the lowest point of the outer profiling is just as low as the diameter of the external thread in the raw state, i.e. before the milling or rolling process.

22. Torque-locked connection according to either claim 20 or claim 21, characterized in that the outer profiling of the shaft, journal or shank is formed of recesses, which extend parallel to the axis of rotation, in the shaft, journal or shank and the profile of the opening is formed with corresponding projections having the shape of a circle sector and comprising in their centre region reliefs having the shape of a circle sector, in such a way that with the inter-engagement of the profilings a cross-section corresponding to the cross-section of a convex lens remains open.

23. Torque-locked connection according to claim 22, an external thread being arranged on the shaft, journal or shank in addition to the profiling, which external thread secures the corresponding hub or disc by screwing a nut onto said external thread, characterized in that the reliefs, having the shape of a circle sector, in the profiled member on the side of the hub or disc are arranged concentrically with the external thread in the assembled state of said hub or disc and have a radius of the circle sectors which is slightly larger than the outer radius of the external thread.

24. Torque-locked connection according to claim 22, characterized in that the depth of the profiled members formed on the shaft, journal or shank decreases in the direction of mounting of the hub or disc.

25. Torque-locked connection according to either claim 20 or claim 21, characterized in that the profiled member on the shaft, journal or shank is produced without cutting production steps exclusively by pressing, rolling and/or milling.

26. Torque-locked connection according to either claim 20 or claim 21, characterized in that at least three, preferably five recesses are formed in the journal or shaft.
